(19) United States
(12) Patent Application Publication
(10) Pub. No.: US 2002/0126310 A1
(43) Pub. Date: Sep. 12, 2002

(54) Information reproduction scheme adapted for printing, having reduced demand on the system bus

(76) Inventors: Philippe Hersberger, Lyss (CH); Herve Wicky, Rufenacht (CH); Daniel Fluckiger, Munsingen (CH); Peter Stutz, Hinterkappelen (CH)

Correspondence Address: PERMAN & GREEN, LLP, 425 Post Road, Fairfield, CT, 06430, US

(21) Appl. No.: 10/081,831

(22) Filed: Feb. 21, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/277,841, filed on Mar. 22, 2001.
(60) Provisional application No. 60/277,873, filed on Mar. 22, 2001.
(60) Provisional application No. 60/277,931, filed on Mar. 22, 2001.
(60) Provisional application No. 60/277,946, filed on Mar. 22, 2001.

(51) Int. Cl. G06F 15/00; G06K 1/00; B41F 1/00; B41B 1/00; B41J 1/00

(52) U.S. Cl. 358/1.15; 358/1.18

(57) ABSTRACT

A method and system for outputting and reproducing information representing a digital image alleviates system bus bottlenecks by downloading image information from the RAM to an Application Specific Integrated Circuit (ASIC), download controlled by the ASIC, and allowing the ASIC to directly interface with and directly control the operation of an output device. The ASIC and the output device are directly connected thereto via a dedicated bus. While the ASIC downloading image information from the RAM, the system processor performs calculations needed for certain portions of the image prior to output and reproduction. In the preferred embodiment, the system is a franking machine, and the output device is an ink jet printer wherein the print heads directly interface with the ASIC. The image, representing postage and other postal-related information, is also arranged so that when it is reproduced on a moving piece of mail or the like, the portion of the image not needing calculations to be finalized, is initially printed. In one embodiment, the calculations are used to calculate the correct postage for the moving piece of mail. The system also novelly includes density control for improving the operation, because more than one ink drop is placed in a pixel, because the image resolution is lower than the physical resolution of the print heads. A lower density can be printed with the same resolution, by printing only one ink drop in the pixel area. This results in a lower ink consummation of the franking machine. It is possible to change between low and high density within one imprint.

### CROSS-REFERENCE TO RELATED APPLICATIONS

This application claims priority of the following U.S. provisional patent applications: Serial No. 60/270,796 filed on Feb. 23, 2001, Serial No. 60/277,806 filed on Mar. 22, 2001, Serial No. 60/277,841 filed on Mar. 22, 2001, Serial No. 60/277,873, filed on Mar. 22, 2001 , Serial No. 60 /277,931 filed on Mar. 22, 2001 , Serial No. 60/277,946 filed on Mar. 22, 2001, Serial No. 60/338,892 filed Nov. 5, 2001 and 60/338,892 filed Nov. 11, 2001.

### FIELD OF THE INVENTION

The present invention is especially relevant to high-volume, digital franking machines that allow users to conveniently place postage inidicia on mail. More generally, however, the present invention is relevant to multi-tasking systems where the system processor is normally taxed with many functions, including downloading a print map for, and controlling printing or other reproduction operations.

### BACKGROUND OF RELATED ART

High-speed digital franking machines, such as those marketed by Ascom Autelca AG, the assignee of the present Letters Patent, are apparatuses that allow a postal customer to both rapidly determine the correct postage for a high volume of mail items, and to affix a postage indicia on the mail item in an automated or semi-automated manner. Determining the correct postage can involve such steps as weighing the mail, sizing the mail, and determining the mail destination. The general components often include: an initial feeder for individually feeding pieces of mail into the machine, a weighing machine for weighing each piece of mail; a user interface for monitoring and controlling the operation of the machine and for entering data as needed, a postage calculator for calculating the correct postage for each piece of mail; a postage affixer for affixing indicia representing the correct postage on each piece of mail; and a machine discharger for discharging the mail from the machine. The postage may be printed on a sticker and then affixed to the flat (e.g., envelope, postcard, etc.) or parcel, or it may be printed directly onto the mail.

An increased demand for franking machines is partly due to the willingness of various postal authorities to allow private parties to generate their own postage indicia, provided there are secure methods for payment, authentication, fraud prevention and the like. Such a system includes the United States Postal Service's Information-Based Indicia Program (IBIP).

Especially where high-speed franking machines are self-contained, the system processor and system bus may handle many tasks that may cause “bottlenecks.” Because calculations may be needed to determine the correct postage, and because rapidly moving mail needs postage stickers and regions to be quickly produced, the system buses of prior art high-speed franking machines are often taxed to their limit, causing delays in the franking process or a reduction in the overall franking speed. The same delays and bus bottlenecking observed for high-speed franking machines are often observed for other operations unrelated to franking, where images are output or reproduced will the system processor must simultaneously perform other tasks which determine the content of the images.

A prior art system 100 that suffers from the aforementioned limitations is generally and schematically illustrated in FIG. 1. A system processor (labeled “microprocessor”) 110 controls the system operation, and performs major computational tasks. The system processor 110 is connected to a number of components, including a Random Access Memory (RAM), which may be more appropriately called a Read and Write Memory 130 (via a bus line 120), and to the print head 150 of a printing device (via control lines 140). FIG. 1 also shows that the RAM 130 is capable of transferring information to the print head 150 (via bus line 160) under the direction of the system processor 110. Those skilled in the art to which the present invention pertains will appreciate that the lines 120, 140 and 160 can be considered to be part of the system bus. The previous paragraph is reiterated with respect to the potential system bus bottlenecks and possible slowing of the printing process for this type of arrangement.

What is therefore lacking in the prior art, but greatly needed, is a system and method for high-speed output or reproduction (e.g., printing) of images, where the images may vary for each reproduction and are determined by the system processor, and where the system bus is not over-taxed by the reproduction function.

It is also desirable to provide such a system with ability to reproduce images or parts of images at lower resolutions to reduce the ink consummation.

### SUMMARY OF THE INVENTION

In view of the above-identified problems and limitations of the prior art, the present invention provides a method of converting and reproducing in a sequential manner, a digital image. The method at least includes the steps of calculating the information representing the digital image by the system processor and storing of this information in a RAM. From this RAM this information is sequentially downloaded to a special purpose digital device, via the system bus coupling. The output of stored information in a user-perceivable form, directly controlling the operation of the output device by the special purpose digital device, and if necessary, contemporaneously with the first step, via the system processor, performing calculations needed to define at least a portion of the digital image.

The present invention also provides a system adapted to convert and reproduce in a sequential manner, a digital image. The system at least includes a system processor, a system bus, a special purpose digital bus coupled to the system processor via the system bus, and an output device directly coupled to the special purpose digital device via a non-system bus coupling, the output device adapted to output digital image information in a user-perceivable form. The system processor is adapted to calculate information representing the digital image and store it into the RAM. The special purpose digital device is adapted to sequentially download the information representing the digital image and control the operation of the output device.

The present invention is described in detail below, with reference to the drawings.

### BRIEF DESCRIPTION OF THE DRAWINGS

Features and advantages of the present invention will become apparent to those skilled in the art from the following description with reference to the drawings, in which:

FIG. 1 (discussed supra) is a general schematic block diagram of a prior art system for postage calculation and printing;

FIG. 2 is a general schematic block diagram of the present-inventive system for postage calculation and printing;

FIG. 3 is a plan view of a print head arrangement compatible with the present invention;

FIG. 4 is an illustration of a flat with a postage indicia area thereon; and

FIG. 5 is an exaggerated example of print pixels which have been printed without the present-inventive density control feature, and print pixels which have been printed with the present-inventive density control feature.

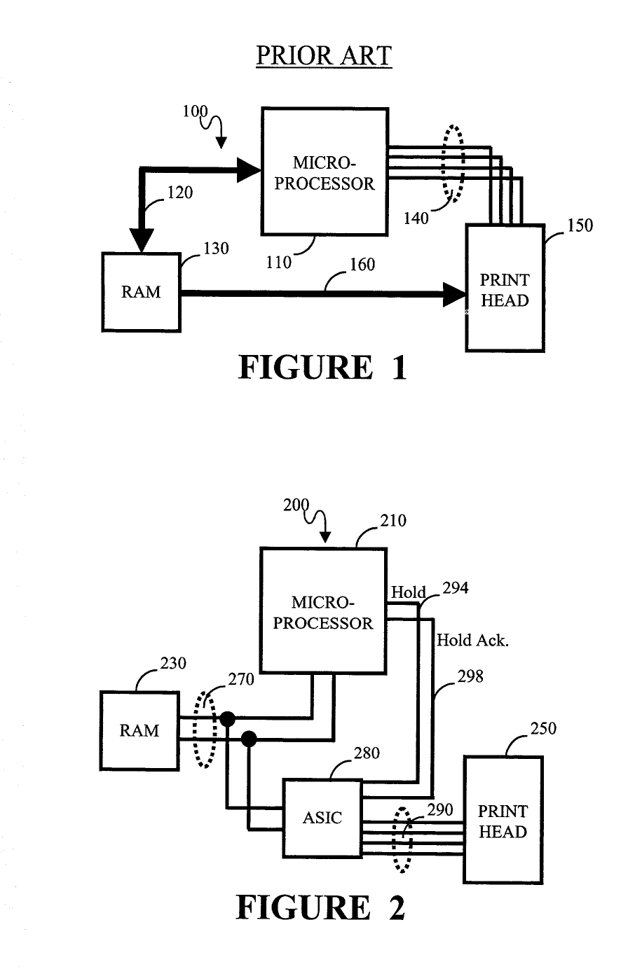

### DETAILED DESCRIPTION OF THE PREFERRED EMBODIMENTS

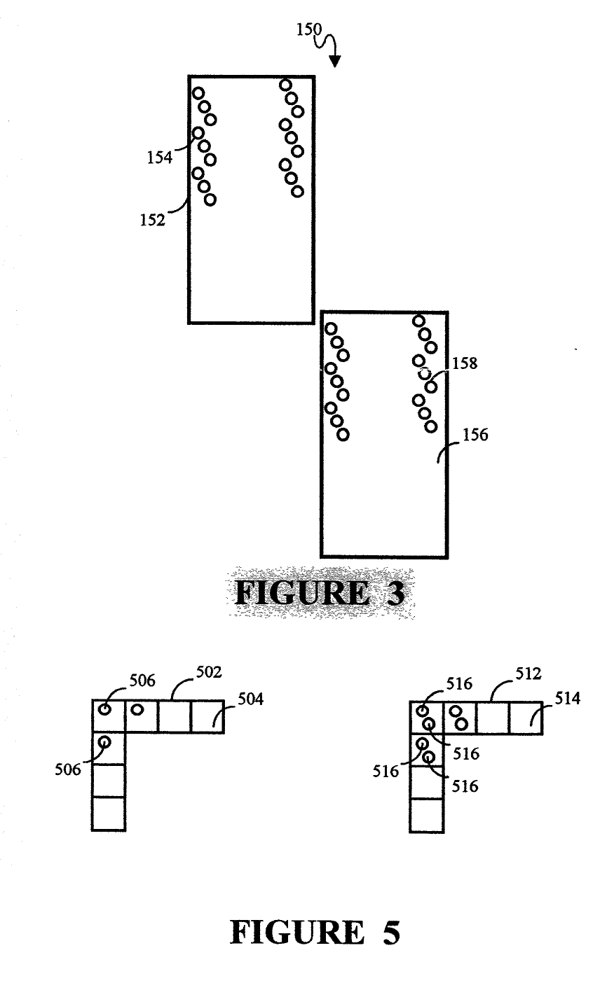

The present-inventive system 200, generally and schematically illustrated in FIG. 2, improves significantly over the aforementioned prior art limitations by novelly including an Application Specific Integrated Circuit (ASIC) 280 to handle the direct control of print heads 250. It should be noted that the system 200 is adapted to operate as part of a high-speed digital franking machine, although the invention is not specifically limited to such applications. A system processor 210 is at least connected to the ASIC 280 and a RAM 230 via a system bus 270. Those skilled in the art will appreciate that component 280 need not be limited to being an ASIC, and that other types of special purpose digital circuits will also suffice.

The system processor 210 initiates the printing of an indicia. Then the ASIC 280 begins to transfer digital image information by scan lines out of the RAM 230. During this data download, the ASIC 280 must be the bus master, what it indicates by setting “hold” signal line 294. The processor sets “hold acknowledge” signal line 298 when it goes into the hold state and is no longer the bus master. Thereafter, the ASIC 280 downloads the needed data and the system processor 210 becomes the bus master again. The ASIC 280 also controls the operation of the print heads 250 and transmits image data thereto via a dedicated bus 290. The system processor 210 is used to calculate the information. With this solution, this calculation can be done while printing. It is also possible to calculate parts of the currently printed image. The bus occupation can be reduced by this solution because it takes less time to download the data sequentially into the ASIC than to transfer the data to the print head and because the system processor doesn't have to concern itself with the transfer to the print head.

In franking machines and similar applications, a portion of the images to be printed relies on the calculations of the system processor before the full image (e.g., postage indicia) is complete. This would further delay prior art approaches that require transferring a print map from the system processor to the printing device before printing actually begins. Instead, the present-inventive system begins printing prior to the transfer of a print map, under the control of the ASIC 280, while the system processor performs any calculations necessary for completing the images to be printed (such as calculating the correct postage).

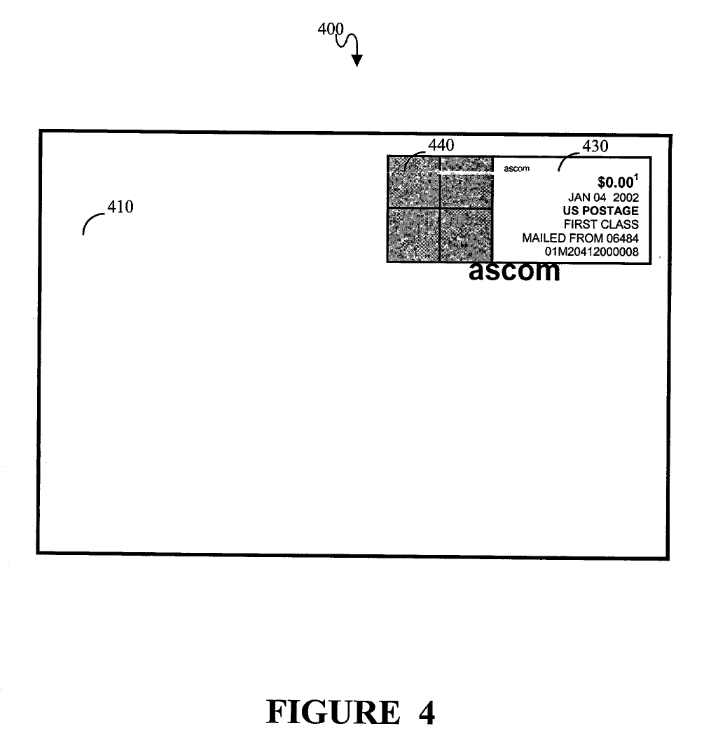

In addition to the advantages obtained by transferring direct printing control from the system processor 210 to the ASIC 280, the present-inventive system 200 also improves upon the prior art by orienting the printing medium (which can be the face of mail, postage stickers, etc.) in a way such that the first portions of the image to traverse the print heads require no calculations before being finalized for printing. FIG. 4 shows an example of a flat 400 with postage indicia divided into two regions 430 and 440. In the example shown, the flat 400 moves from left to right past the print heads. Therefore region 430 will be printed (or at least started) prior to region 440, which has IBIP indicia needing calculations before the latter portion of the image can be finalized. Printing can begin before all calculations are performed to save time. The dividing point between the two regions is referred to as the validation point. If the validation point is reached before the calculations are complete, the printing can be aborted without franking. Therefore, there is no loss of money.

FIG. 5 illustrates an example of a print head arrangement 150 compatible with the present-inventive system and method. The print head arrangement 150 contains two print heads 152 and 156, each having two rows of staggered print nozzles 154 and 158.

A further aspect of the printing operation of the present-inventive system and method is the ability to control the density of ink for each printed pixel, as illustrated in FIG. 5. On the right side of FIG. 5 is a group 512 of pixels 514 (with greatly exaggerated size) with normal print density. That is, two ink drops per pixel area are used. In contrast, the example 502 on the left of FIG. 5 illustrates a reduced density of pixels 504 by including one ink drop 506 for each printed pixel. From the examples in FIG. 5, it can be seen that at lower density printing, the system has the same resolution than with normal density, but the ink consummation is reduced. In order to provide equal usage of all nozzles, the two rows are activated alternatively on subsequent imprints.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A method of converting and reproducing in a sequential manner, a digital image comprising the steps of:
a) via a system processor, sequentially downloading information representing said digital image to a special purpose digital device;
b) via an output device directly coupled to said special purpose digital device via a non-system bus coupling, outputting digital image information in a user-perceivable form;
c) directly controlling the operation of said output device by said special purpose digital device; and
d) if necessary, contemporaneously with step a), said system processor performing calculations needed to define at least a portion of said digital image.

2. The method of claim 1, wherein said special purpose digital device is an Application Specific Integrated Circuit (ASIC).

3. The method of claim 1, wherein said output device is a printing apparatus.

4. The method of claim 1, wherein the steps are subsumed by a franking machine.

5. The method of claim 4, wherein at least a portion of said calculations are used to establish a postage amount for a prospective item to be mailed.

6. The method of claim 1, wherein said digital image comprises postage indicia.

7. The method of claim 1, further comprising the steps of:
e) grouping said digital image into at least a first output region and a second output region, wherein said second output region contains at least some image information needing calculations prior to outputting;
f) outputting and reproducing information corresponding to said first output region on an output medium moving relative to said output device, wherein at least initial output positions in said first output region are reached before said second output region;
g) performing step d) contemporaneously with step f); and
h) outputting and reproducing calculated information corresponding to said second region after at least a portion of said first region.

8. The method of claim 6, wherein said moving medium comprises the surface of a postal flat.

9. The method of claim 6, wherein said moving medium comprises a mailing label.

10. The method of claim 3, wherein said printing apparatus is of the ink jet variety, said method further comprising the step of:
for an output resolution lower than the printing apparatus limit, increasing the density of each output pixel by printing in each pixel location, more than one printing drop.

11. A system adapted to convert and reproduce in a sequential manner, a digital image, said system comprising:
a system processor;
a system bus;
a special purpose digital bus coupled to said system processor via said system bus; and
an output device directly coupled to said special purpose digital device via a non-system bus coupling, said output device adapted to output digital image information in a user-perceivable form;
wherein said system processor is adapted to sequentially download information representing said digital image to said special purpose digital device, and is adapted to, if necessary, and contemporaneously with sequentially download information representing said digital image to said special purpose digital device, perform calculations needed to define at least a portion of said digital image; and
wherein said special purpose digital device is adapted to control the operation of said output device.

12. The system of claim 11, wherein said special purpose digital device is an Application Specific Integrated Circuit (ASIC).

13. The system of claim 11, wherein said output device is a printing apparatus.

14. The system of claim 11, wherein the components are subsumed by a franking machine.

15. The system of claim 14, wherein at least a portion of said calculations are used to establish a postage amount for a prospective item to be mailed.

16. The system of claim 11, wherein said digital image comprises postage indicia.

17. The system of claim 11, further defined as:
wherein said system processor is further adapted to group said digital image into at least a first output region and a second output region, wherein said second output region contains at least some image information needing calculations prior to outputting;
wherein said output device is further adapted to output and reproduce information corresponding to said first output region on an output medium moving relative to said output device, wherein at least initial output positions in said first output region are reached before said second output region;
wherein said system processor is further adapted to perform calculations contemporaneously with said output device outputting at least initial output positions in said first output region; and
wherein said output device is further adapted to output and reproduce calculated information corresponding to said second region after at least a portion of said first region.

18. The system of claim 16, wherein said moving medium comprises the surface of a postal flat.

19. The system of claim 16, wherein said moving medium comprises a mailing label.

20. The system of claim 13, wherein said printing apparatus is of the ink jet variety, and said special purpose digital device and said printing apparatus cooperating and adapted to, for an output resolution lower than the printing apparatus limit, increase the density of each output pixel by printing in each pixel location, more than one printing drop.

21. A method of converting and reproducing in a sequential manner, a digital image comprising the steps of:
a) Calculating the information representing said digital image by the system processor and storing it into a RAM;
b) sequentially downloading information from the RAM into the special purpose digital device controlled by the special purpose digital device;
c) outputting digital image information in a user-perceivable form via an output device directly coupled to said special purpose digital device via a non-system bus coupling;
d) directly controlling the operation of said output device by said special purpose digital device; and
e) if necessary, contemporaneously with step a), performing calculations needed to define at least a portion of said digital image by said system processor.

22. The method of claim 21, further comprising the steps of:
f) grouping said digital image into at least a first output region and a second output region, wherein said second output region contains at least some image information needing calculations prior to outputting;
g) outputting and reproducing information corresponding to said first output region on an output medium moving relative to said output device, wherein at least initial output positions in said first output region are reached before said second output region;
h) performing step e) contemporaneously with step g); and
i) outputting and reproducing calculated information corresponding to said second region after at least a portion of said first region.

23. A system adapted to convert and reproduce in a sequential manner, a digital image, said system comprising:
a system processor;
a system bus;
a special purpose digital bus coupled to said system processor via said system bus; and
an output device directly coupled to said special purpose digital device via a non-system bus coupling, said output device adapted to output digital image information in a user-perceivable form;
wherein said system processor is adapted to calculate the information and store it into the RAM and is adapted to, if necessary, and contemporaneously with sequentially download information representing said digital image to said special purpose digital device, perform calculations needed to define at least a portion of said digital image; and
wherein said special purpose digital device is adapted to control the operation of said output device and to sequentially download information representing said digital image from the RAM into this special purpose digital device, operation controlled by this special purpose digital device.
